(19) United States
(12) Patent Application Publication
(10) Pub. No.: US 2017/0337898 A1
(43) Pub. Date: Nov. 23, 2017

(54) DISPLAY DEVICE HAVING LIGHT ADJUSTING MODULE AND CONTROL METHOD THEREOF

(71) Applicant: AU Optronics Corporation, Hsin-Chu (TW)

(72) Inventors: Shu-Wen LIAO, Hsin-Chu (TW); Kuan-Yu Tung, Hsin-Chu (TW); Ken-Yu Liu, Hsin-Chu (TW)

(21) Appl. No.: 15/586,530

(22) Filed: May 4, 2017

(30) Foreign Application Priority Data
May 19, 2016 (TW) 105115504

(51) Int. Cl. G09G 5/10; G09G 3/34

(52) U.S. Cl. CPC G09G 5/10; G09G 3/3406; G09G 2354/00; G09G 2320/0626

(57) ABSTRACT

A display device having a light adjusting module and a control method thereof are provided. The display device includes a light source module, a light adjusting module, a display panel, and an eye detection device. The light source module has a light emitting surface. The light adjusting module has a plurality of predetermined positions, which is disposed on one side of the light source module corresponding to the light emitting surface. The display panel is disposed on the other side of the light adjusting module with respect to the light source module and has a display surface. The eye detection device is adjacent to the display surface for detecting an eye position of a user located in front of the display panel. The light adjusting module is capable of adjusting an optical property of the plurality of predetermined positions in accordance with the detected eye position and a light field of the light source module.

### BACKGROUND

### Technical Field

The present invention relates to a display device having a light adjusting module and a control method thereof.

### Related Art

As shown in FIG. 1, it is known that when a display device is designed, generally, light intensities of nine positions P1-P9 on a display panel 50 are vertically measured, and backlight is adjusted in accordance with the light intensities, so as to enable light emitted from the display device to be uniformly distributed. The selection of the nine positions P1-P9 is based on a concept of equally dividing the panel 50 into nine parts and selecting centers of the nine equal parts. However, when viewing the display device, a user easily feels a relatively large brightness difference among positions on the display panel because an eye position with respect to the display device is not fixed.

Specifically, when the eye of the user is located at a central position directly in front of the display panel 50, the user feels different light intensities of the positions because distances between the eye and the nine positions P1-P9 on the display panel are different. For example, a distance between the eye and the position P5 is the shortest because the eye of the user is located at the central position directly in front of the display panel 50, and therefore, a light intensity at the position P5 is greater than light intensities of the positions P2, P4, P6, and P8, which are greater than light intensities of the positions P1, P3, P7, and P9. The feeling of the light intensity differences among the positions affects the viewing comfort of the user, and therefore needs to be improved.

### SUMMARY

A main objective of the present invention is to provide a display device and a control method thereof, so as to improve the viewing comfort of users. The display device includes a light source module, a light adjusting module, a display panel, and an eye detection device. The light source module has a light emitting surface. The light adjusting module has a plurality of predetermined positions, which is disposed on one side of the light source module corresponding to the light emitting surface. The display panel is disposed on the other side of the light adjusting module with respect to the light source module and has a display surface. The eye detection device is adjacent to the display surface and is configured to detect an eye position of a user located in front of the display panel. The light adjusting module is capable of adjusting optical properties of the plurality of predetermined positions of the light adjusting module in accordance with the eye position detected by the eye detection device and a light field of the light source module.

The light adjusting module is capable of adjusting an optical property of the plurality of predetermined positions of the light adjusting module in accordance with a perpendicular distance between the eye position detected by the eye detection device and the display panel.

The light adjusting module is capable of adjusting the optical property of the plurality of predetermined positions on the light adjusting module in accordance with a perpendicular distance between the eye position and a central normal line of the display surface.

The light adjusting module is capable of adjusting haze of the plurality of predetermined positions of the light adjusting module in accordance with the eye position detected by the eye detection device.

When the eye position detected by the eye detection device is located right in front of the display panel, the light adjusting module is capable of adjusting the haze of the light adjusting module to be gradually decreased from a center to an outside.

When the eye position detected by the eye detection device is located diagonally in front of the display panel, the light adjusting module is capable of adjusting the haze of the light adjusting module to be gradually decreased from a first position closest to the eye position to a second position farthest from the eye position.

The light adjusting module includes a voltage adjusting module and a liquid crystal layer. The voltage adjusting module has a plurality of first electrodes arranged along a first direction and a plurality of second electrodes arranged along a second direction different from the first direction. The liquid crystal layer determines a state in accordance with a voltage difference between a first electrode and a second electrode intersected at a position, so as to adjust the haze of the light adjusting module of the position. The liquid crystal layer is of cholesteric liquid crystals or Polymer Dispersed Liquid Crystals (PDLCs).

The light adjusting module is capable of adjusting the light flux of the plurality of predetermined positions of the light adjusting module in accordance with the eye position detected by the eye detection device.

When the eye position detected by the eye detection device is located right in front of the display panel, the light adjusting module is capable of adjusting the light flux of the light adjusting module to be gradually increased from a center to an outside.

When the eye position detected by the eye detection device is located diagonally in front of the display panel, the light adjusting module is capable of adjusting the light flux of the light adjusting module to be gradually increased from a first position closest to the eye position to a second position farthest from the eye position.

A display device control method includes: (A) providing an emitted light by the light source module, so as to enable the emitted light from the light source module to transmit through the light adjusting module; (B) detecting an eye position of a user by the eye detection device, and so as to obtain an eye position signal in accordance with the eye position; (C) receiving, by the light adjusting module, the emitted light from the light source module, and adjusting an optical property of the plurality of predetermined positions on the light adjusting module in accordance with the eye position signal and the light field of the light source module, so as to adjust optical properties of the emitted light transmitted through the light adjusting module; and (D) receiving, by the display panel, the light adjusted by the light adjusting module, and enabling the adjusted light to transmit through the display panel and to be emitted from the display surface.

In step (B), a perpendicular distance between the eye position of the user and the display panel is detected the eye detection device, and the eye position signal is obtained in accordance with the vertical distance.

In step (B), a perpendicular distance between the eye position of the user and a central normal line of the display surface is detected by the eye detection device, and the eye position signal is obtained in accordance with the perpendicular distance.

In step (C), haze of the plurality of predetermined positions on the light adjusting module is adjusted by the light adjusting module in accordance with the eye position signal.

In step (C), when the eye position detected by the eye detection device is located right in front of the display panel, the haze of the light adjusting module is adjusted to be gradually decreased from a center to an outside.

In step (C), when the eye position detected by the eye detection device is located diagonally in front of the display panel, the haze of the light adjusting module is adjusted to be gradually decreased from a first position closest to the eye position to a second position farthest from the eye position.

In step (C), the light flux of the plurality of predetermined positions of the light adjusting module is adjusted in accordance with the eye position signal.

In step (C), when the eye position detected by the eye detection device is located right in front of the display panel, the light flux of the light adjusting module is adjusted to be gradually increased from a center to an outside.

In step (C), when the eye position detected by the eye detection device is located diagonally in front of the display panel, the light flux of the light adjusting module is adjusted to be gradually increased from the first position closest to the eye position to the second position farthest from the eye position.

### BRIEF DESCRIPTION OF THE DRAWINGS

FIG. 1 is a schematic diagram of the prior art;

FIG. 2A is a schematic diagram of an embodiment of a display device according to the present invention;

FIG. 2B is a schematic diagram of an embodiment in which a light adjusting module has a plurality of predetermined positions;

FIG. 3 is a schematic diagram of an embodiment showing an eye position located directly in front of a display panel, and a measured light intensity change;

FIG. 4 is a schematic diagram of an embodiment showing an eye position located diagonally in front of a display panel, and a measured light intensity change;

FIG. 5 is a schematic diagram of an embodiment in which a light adjusting module does not perform an operation;

FIG. 6 is a schematic diagram of an embodiment in which haze of a light adjusting module gradually decreases from the center to the outside;

FIG. 7 is a schematic diagram of another embodiment in which haze of a light adjusting module gradually decreases from the center to the outside;

FIG. 8A is a schematic diagram of an embodiment showing a distance between an eye position in a plane parallel to a display surface and a central normal line of the display surface;

FIG. 8B is a schematic diagram of an embodiment in which haze of a light adjusting module gradually decreases from a first side to a second side;

FIG. 9A is a cross-sectional view of an embodiment in which no voltage is applied to a light adjusting module;

FIG. 9B is a schematic diagram of an embodiment of a voltage adjusting module;

FIG. 9C is a cross-sectional view of an embodiment in which a voltage is applied to the light adjusting module;

FIG. 10A is a schematic diagram showing a measurement result of the original light field of a light source module according to an embodiment of the present invention;

FIG. 10B is a schematic diagram of a haze state of a traditional light scattering film;

FIG. 10C is a schematic diagram of a measurement result of the light field measured at a preset eye position after a traditional light scattering film is used according to an embodiment of the present invention;

FIG. 10D is a schematic diagram of a haze state after a light adjusting module adjusts optical properties of a plurality of predetermined positions on the light adjusting module according to an embodiment of the present invention;

FIG. 10E is a schematic diagram of a measurement result of the light field measured at a preset eye position after a display device of the present invention is used according to an embodiment of the present invention; and

FIG. 11 is a flowchart of an embodiment of a display device control method according to the present invention.

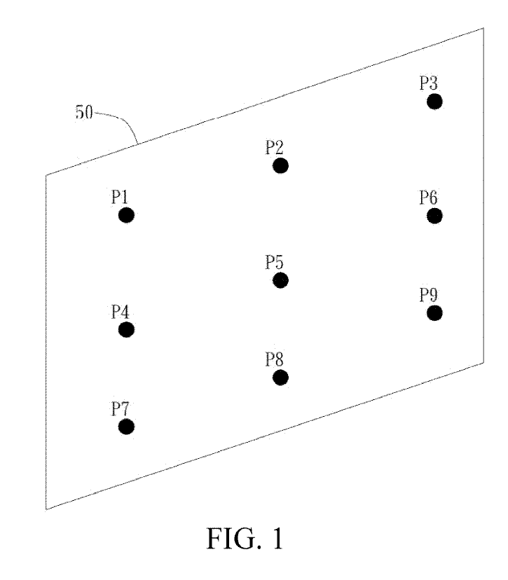

### DETAILED DESCRIPTION

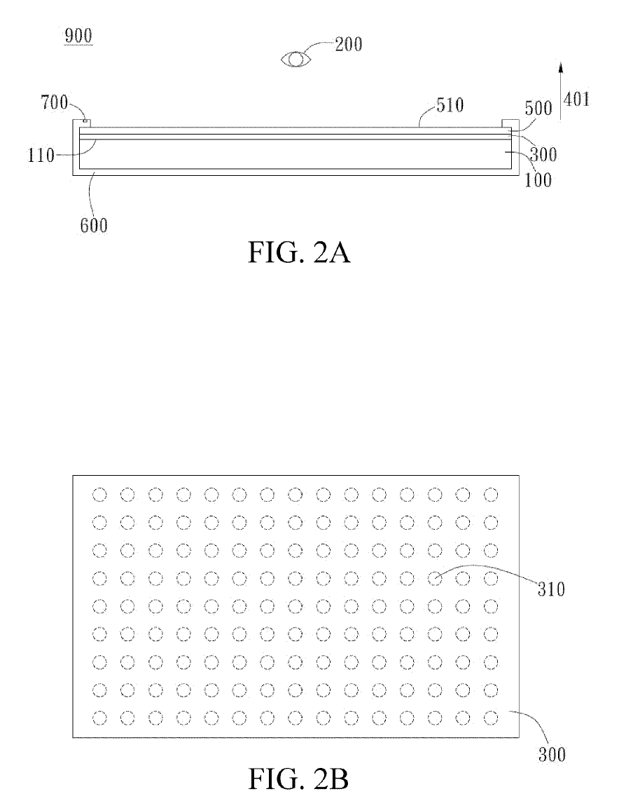

In a preferred embodiment shown in FIG. 2A, a display device 900 of the present invention includes a light source module 100, a light adjusting module 300, a display panel 500, an outer frame 600, and an eye detection device 700. The light source module 100 has a light emitting surface 110. The light adjusting module 300 is disposed on one side of the light source module 100 corresponding to the light emitting surface 110. In an embodiment shown in FIG. 2B, the light adjusting module 300 has a plurality of predetermined positions 310. The predetermined positions 310 may be “points”, for example, or may be “blocks” in a different embodiment. Arrangements of positions and density of the predetermined positions 310 may be different in accordance with manufacturing or design requirements.

In the embodiment shown in FIG. 2A, the display panel 500 is disposed on the other side of the light adjusting module 300 with respect to the light source module 100, and has a display surface 510 located at a side far away from the light adjusting module 300. The outer frame 600 is adopted to accommodate the light source module 100, the light adjusting module 300, and the display panel 500. The eye detection device 700 is disposed on an outer surface of the outer frame 600 and includes an infrared sensor facing a direction 401. However, in a different embodiment, a form and an arrangement position of the eye detection device 700 may be determined in accordance with an operation principle of the eye detection device 700. The eye detection device 700 is adjacent to the display surface 510, faces a direction the same as a direction that the display surface 510 faces (which is the direction 401 in this embodiment), and is adopted to detect a position and a distance of an eye 200 of a user located in front of the display surface 501 of the display panel 500.

In the display device 900 of this embodiment, the light adjusting module 300 adjusts optical properties, such as haze and light flux, of the plurality of predetermined positions 310 on the light adjusting module 300 in accordance with the position and distance of the eye 200 detected by the eye detection device 700 and the light field of the light source module 100. More specifically, the light adjusting module 300 individually adjusts optical properties of the plurality of predetermined positions 310 of the light adjusting module 300 in accordance with different positions and distances of the eye 200 with respect to the display panel 500 that are detected by the eye detection device 700 and states of the light field of the light source module 100, that is, differentially adjusts the optical properties of the plurality of predetermined positions 310 on the light adjusting module 300. Viewing from the angle of a light path, the light source module 100 emits light from the light emitting surface 110, the light transmits through the light adjusting module 300 and travels towards the display panel 500, the light from the light adjusting module 300 transmits through the display panel 500 and is emitted from the display surface 510, and the light adjusting module 300 differentially adjusts light behaviors of the plurality of predetermined positions 310 of the light adjusting module 300 in accordance with the position and distance of the eye 20 detected by the eye detection device 700 and the light field of the light source module 100.

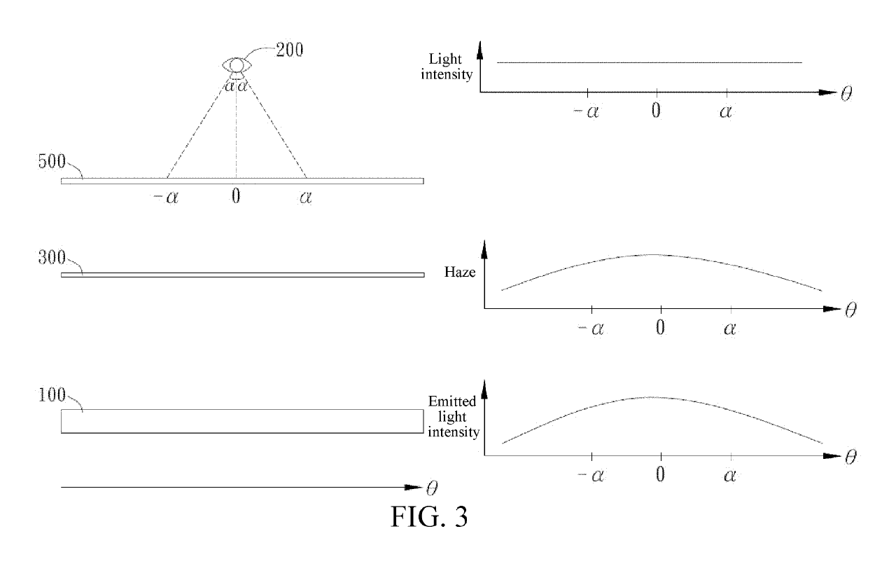

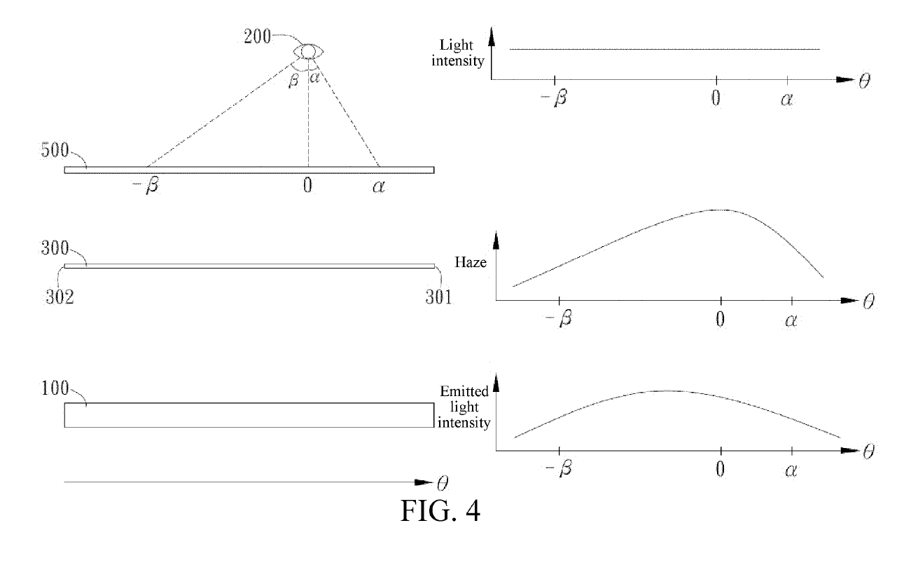

Subsequently, referring to FIG. 3, when the eye 200 is located at a central position right in front of the display panel 500, the light field of the light source module 100 has a relatively high light intensity at the central position with respect to the display panel 500. At this time, the light adjusting module 300 is adjusted, so as to increase the haze of predetermined positions 310 close to the center of the light adjusting module 300, such that a light intensity of the light emitted by the light source module 100 and transmitted through the light adjusting module 300 and the display panel 500 is relatively uniform when the light is viewed by a user from the position of the eye 200. For specific adjustment methods, refer to the description of the later embodiments. On the other hand, in the embodiment shown in FIG. 4, the eye 200 is located diagonally in front of the display panel 500, for example, at a position slightly deviating from the center towards the right, and the light field of the light source module 100 still has a relatively high emitted light intensity at the center. At this time, the light adjusting module 300 is adjusted in accordance with the detected position of the eye 200, so as to increase the haze of predetermined positions 310 close to the eye 20 and decrease the haze of predetermined positions 310 far away from the eye 200, thereby enabling the light intensity of light viewed by a user from the position of the eye 200 to be relatively uniform. By means of the foregoing adjustments, overall brightness of the display panel 500 viewed from the position of the eye 200 is relatively uniform, and viewing comfort is improved.

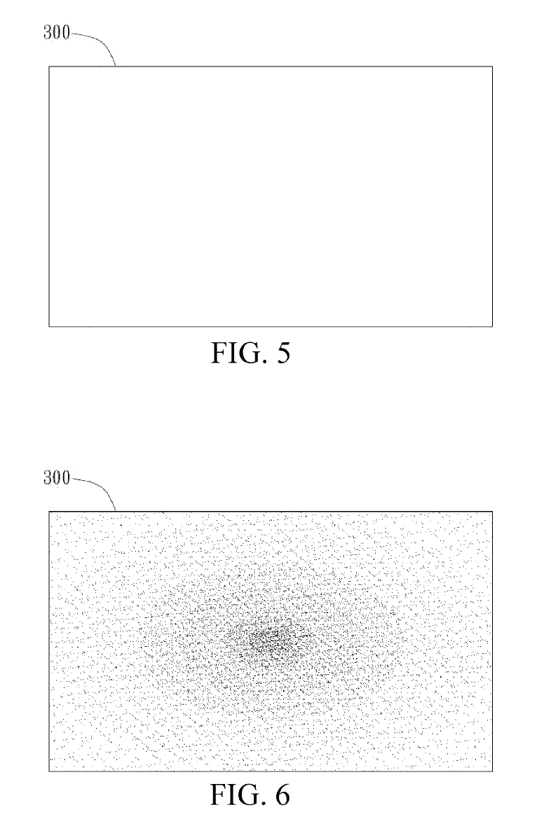

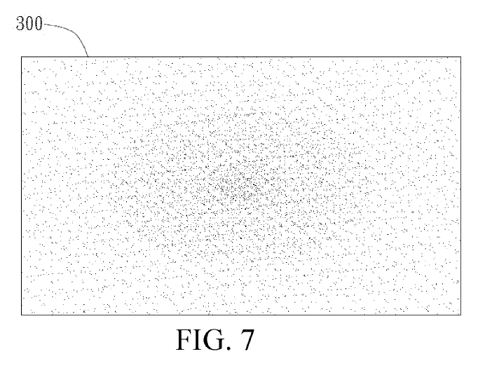

Further, the light adjusting module can adjust the optical properties of the plurality of predetermined positions 310 of the light adjusting module 300 in accordance with a perpendicular distance between the eye 200 and the display panel detected by the eye detection device, that is, the amount of space between the eye 200 and the display panel. In the embodiment shown in FIG. 5, when an eye detection device fail to detect an eye or a detected eye position is not within a preset range (e.g. the detected eye position is excessively far away from the display panel), the light adjusting module does not perform an operation, and optical properties of points of the light adjusting module are of no special differences. In the embodiment shown in FIG. 6, when the eye 200 is located at the central position right in front of the display panel 500 (referring to FIG. 3), the light adjusting module 300 is adjusted, so as to increase the haze of predetermined positions 310 close to the center of the light adjusting module 300, that is, to gradually decrease the haze of the light adjusting module 300 from the center to the outside, such that a light scattering degree increases from the outside to the center of the light adjusting module 300, that is, light flux of the light adjusting module 300 gradually increases from the center to the outside. However, when the eye 200 moves to a position relatively far away from the position right in front of the display panel 500, because a light intensity non-uniform state felt by a user is less severe, in the embodiment shown in FIG. 7, the light adjusting module 300 is adjusted, so as to slightly decrease the haze of the predetermined positions close to the center of the light adjusting module 300 as compared with the haze of those in the embodiment shown in FIG. 6.

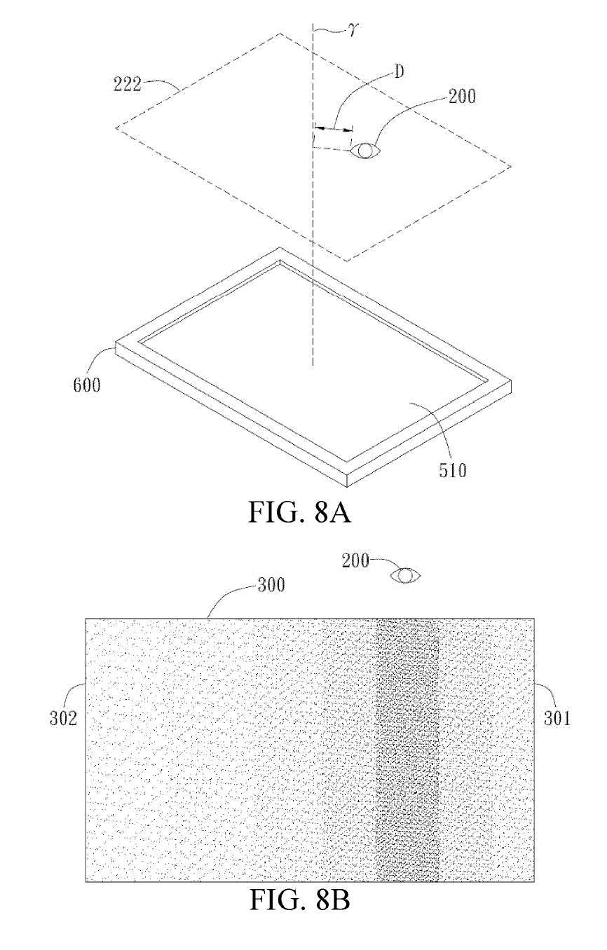

In the embodiment shown in FIG. 8A, in a different embodiment, the light adjusting module adjusts the optical properties of the plurality of predetermined positions of the light adjusting module in accordance with a distance D between the eye position in a plane 222 parallel to the display surface 510 that is detected by the eye detection device and a central normal line γ of the display surface. In other words, the distance D is a perpendicular distance or a shortest distance between the eye position and the central normal line γ of the display surface. Specifically, in the embodiment shown in FIG. 8B, when the eye 200 detected by the eye detection device is located diagonally in front of the display panel 500 (referring to FIG. 4), for example, at a position slightly deviating from the center towards the right, the light adjusting module 300 is adjusted, so as to decrease the haze of the light adjusting module 300 from a position slightly deviating from a center of the light adjusting module 300 closest to the eye position to a first side 301 and a second side 302 far away from the eye position 200, such that a light scattering degree gradually decreases from the position slightly deviating from the center of the light adjusting module 300 closest to the eye position 200 to the first side 301 and the second side 302 far away from the eye position 200.

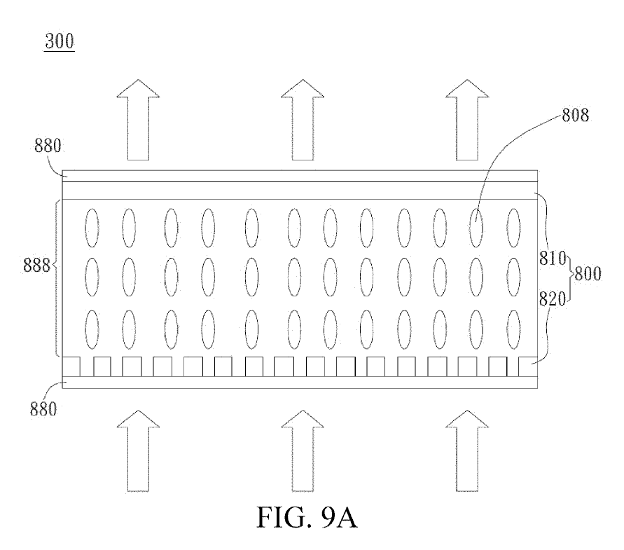

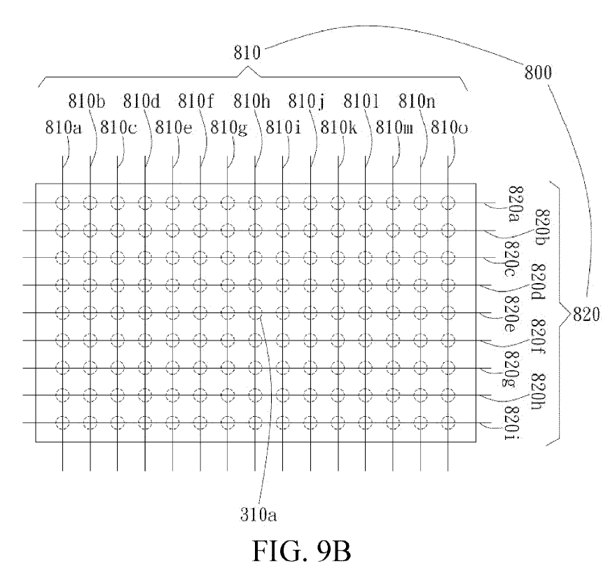

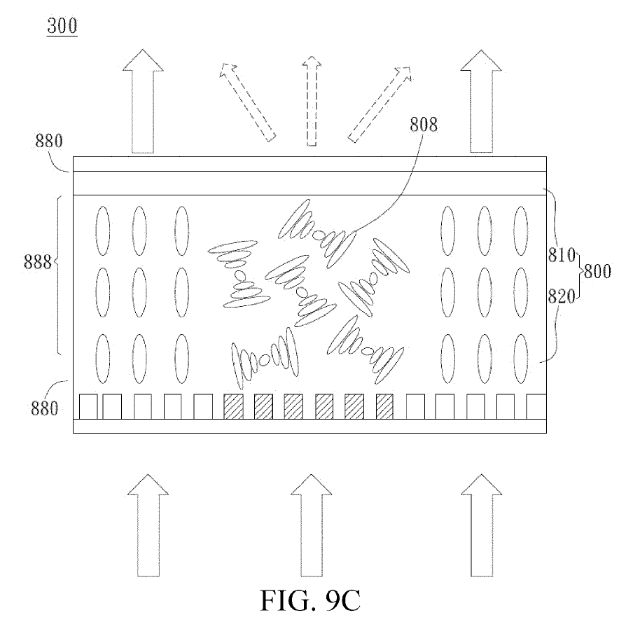

In the embodiment shown in FIG. 9A, the light adjusting module 300 includes a voltage adjusting module 800 and a liquid crystal layer 888. In this embodiment, the voltage adjusting module 800 and the liquid crystal layer 888 are located between two light transmissive substrates 880; the liquid crystal layer 888 is of cholesteric liquid crystals 808; and when liquid crystal molecules are in penetration states with no voltage being applied, the light can directly transmit through the liquid crystal molecules, and at this time, the haze is the lowest and the light flux of the liquid crystal molecules is the largest. In the embodiment shown in FIG. 9B, the voltage adjusting module 800 includes a plurality of first electrodes 810 arranged along a horizontal axis (a first direction) and located at an upper substrate and a plurality of second electrodes 820 arranged along a vertical axis (a second direction) and located at a lower substrate, and the cholesteric liquid crystals 808 are sandwiched between the plurality of first electrodes 810 and the plurality of second electrodes 820. The cholesteric liquid crystals 808 determine a state in accordance with a voltage difference between a first electrode 810 and a second electrode 820 intersected at a position 310a, so as to adjust the haze or the light flux of the light adjusting module 300 of the position. In the embodiment shown in FIG. 9C, when a first electrode 810 and a second electrode 820 close to the center have a voltage difference, the cholesteric liquid crystals 808 between the first electrode 810 and the second electrode 820 change an arrangement manner, so as to enable the transmitted light to be scattered. More specifically, for example, if the haze of the light adjusting module 300 is desired to be decreased from the center to the outside, a voltage difference between a first electrode 810h and a second electrode 820e intersected at a predetermined position 310a close to the center may be enabled to be the largest, and the voltage difference between two electrodes gradually decreases from the predetermined position 310a, as the center, to the outside, such that the haze of the center of the light adjusting module 300 is the largest and the haze gradually decreases from the center to the outside, and the light flux of the center is the smallest and the light flux increases from the center to the outside. Voltages of the first electrodes 810a-810o and the second electrodes 820a-820i can be individually adjusted and set. Therefore, a voltage difference of each predetermined position 310a at an intersection can be adjusted by adjusting and setting the voltages of the first electrodes 810a-810o and the second electrodes 820a-820i, so as to determine a state of cholesteric liquid crystals at this position, thereby controlling an optical property, the haze, of the position of the light adjusting module 300. In a different embodiment, another substance whose properties can be changed on the basis of a voltage difference may be used to replace cholesteric liquid crystals, for example, PDLCs may be used. Both of the cholesteric liquid crystal and the PDLC have different forms allowing transmission and scattering of light. An additional voltage needs to be continuously applied to the PDLC, so as to keep the PDLC in a stable state. However, by means of addition of a polymer monomer, the cholesteric liquid crystal can achieve a bi-stable state (transmission and scattering), an additional voltage only needs to be applied in switchover of states, and no power is required to keep the cholesteric liquid crystal in a stable state in other situations than switchover. Therefore, the cholesteric liquid crystal and the PDLC can be replaced with each other in accordance with design or usage requirements.

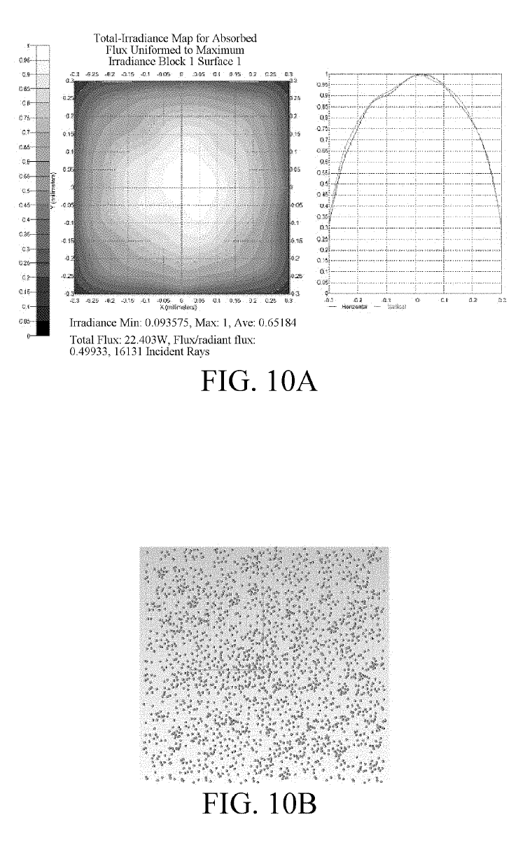

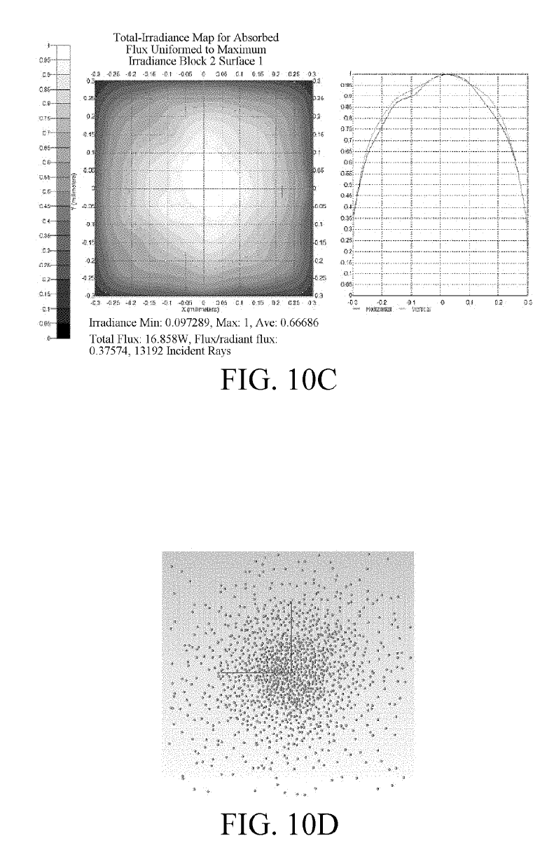

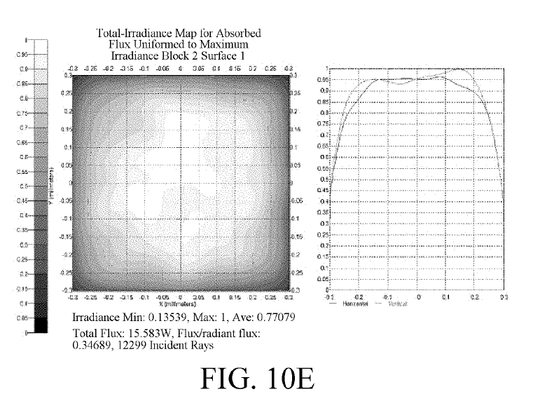

A measurement result of the original light field of the light source module is as shown in FIG. 10A. A figure of a haze state of a traditional scattering film is as shown in FIG. 10B, and a measurement result of the light field measured from a preset eye position after a traditional scattering film is used is as shown in FIG. 10C. Comparing FIG. 10A with FIG. 10C, it can be discovered that the use of the traditional scattering film does not result in an obvious difference between the light field measured at the preset eye position and the original light field of the light source module. On the other hand, with regard to a case in which the display device of the present invention is used, after optical properties of the plurality of predetermined positions of the light adjusting module are adjusted, a figure of a haze state is as shown in FIG. 10D, and a measurement result of the light field measured at the preset eye position when the display device of the present invention is used is as shown in FIG. 10E. Comparing FIG. 10A with FIG. 10E, it can be clearly discovered that with the use of the display device of the present invention, the light field measured at the preset eye position is more uniform as compared with the original light field of the light source module. Therefore, the overall brightness of the display device of the present invention is relatively uniform, and the viewing comfort of users can be improved.

In the present invention, the light adjusting module adjusts optical properties of a plurality of predetermined positions of the light adjusting module in accordance with a position and a distance of an eye detected by the eye detection device. In the aforementioned embodiments, the optical property of haze is adjusted, that is, a light scattering degree is adjusted. However, in a different embodiment, the optical properties are not limited to the haze, and may also include the light flux and the like. More specifically, an element such as a grating may be used to control the amount of transmitted light, so as to adjust the light flux of the light adjusting module.

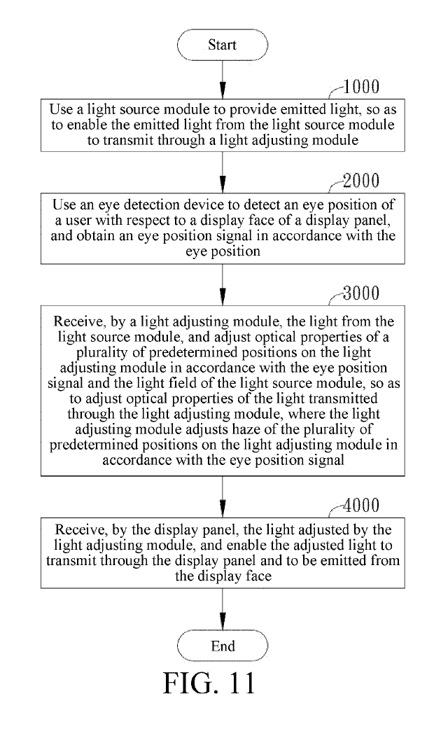

In the flowchart shown in FIG. 11, a control method of the display device according to the aforementioned embodiments includes the following steps 1000, 2000, 3000, and 4000.

Step 1000: Use a light source module to provide emitted light, so as to enable the emitted light from the light source module to transmit through a light adjusting module. More specifically, as described in the embodiment shown in FIG. 2A, the light source module 100 provides emitted light and the emitted light transmits through the light emitting surface 100.

Step 2000: Use an eye detection device to detect an eye position of a user with respect to a display surface of a display panel, and obtain an eye position signal in accordance with the eye position. More specifically, as described in the embodiment shown in FIG. 2A, the eye detection device 700 detects a position of the eye 200 of a user with respect to the display surface 510 of the display panel 500, and obtains an eye position signal in accordance with the eye position. The eye detection device detects a perpendicular distance between the eye of the user and the display surface of the display panel, and the eye detection device may synchronously detect a distance between the eye of the user in a plane 222 parallel to the display surface 510 and a central normal line of the display panel (referring to FIG. 8A), and obtains the eye position signal in accordance with the detected distances. Further, the eye position signal reflects the perpendicular distance between the eye 200 and the display panel and the distance between the eye 200 and the central normal line of the display panel.

Step 3000: Receive, by a light adjusting module, the emitted light from the light source module, and adjust optical properties of a plurality of predetermined positions of the light adjusting module in accordance with the eye position signal and the light field of the light source module, so as to adjust optical properties of the light transmitted through the light adjusting module. More specifically, a processing module of the display device performs calculation in accordance with the received eye position signal and information about the light field of the light source module, and subsequently sends an adjusting signal, so as to adjust the optical properties of the plurality of predetermined positions (referring to FIG. 2B) of the light adjusting module 300 in the embodiment shown in FIG. 2A. The light adjusting module adjusts the haze of the plurality of predetermined positions of the light adjusting module in accordance with the eye position signal. More specifically, as described in the aforementioned embodiments, a voltage difference is used to control a state of a cholesteric liquid crystal, a PDLC, or another substance or element, so as to adjust the haze. When the eye position detected by the eye detection device is located right in front of the display panel, the light adjusting module is adjusted to gradually decrease the haze of the light adjusting module from the center to the outside. More specifically, as described in the embodiment shown in FIG. 6, the light adjusting module 300 is adjusted to gradually decrease the haze of the light adjusting module 300 from the center to the outside.

When the eye position detected by the eye detection device is located diagonally in front of the display panel, the light adjusting module adjusts the haze of the light adjusting module to be gradually decreased from a position closest to the eye to two sides farthest from the eye position. More specifically, as described in the embodiment shown in FIG. 8, the light adjusting module 300 adjusts the haze of the light adjusting module 300 to be gradually decreased from the position closest to the eye 200 to the two sides.

In a different embodiment, in step 3000, the light adjusting module adjusts the light flux of the plurality of predetermined positions of the light adjusting module in accordance with the eye position signal. More specifically, an element such as a grating may be used to control the amount of transmitted light, so as to adjust the light flux of the light adjusting module.

When the eye position detected by the eye detection device is located right in front of the display panel, the light adjusting module adjusts the light flux of the light adjusting module to be gradually increased from the center to the outside.

When the eye position detected by the eye detection device is located diagonally in front of the display panel, the light adjusting module adjusts the light flux of the light adjusting module to be gradually increased from a position closest to the eye to positions farthest from the eye.

Step 4000: Receive, by the display panel, the light adjusted by the light adjusting module, and enable the adjusted light to transmit through the display panel and to be emitted from the display surface.

Although the preferred embodiments of the present invention are disclosed by using the foregoing description and figures, it should be understand that various additions and many modifications and replacements may be applied to the preferred embodiments of the present invention without departing from the spirit and scope of the principle of the present invention as defined by the appended claims. A person of ordinary skill in the art may understand that modifications of many forms, structures, arrangements, ratios, materials, elements, and components may be applied to the present invention. Therefore, the embodiments disclosed in this specification shall be construed as intended to describe the present invention rather than intended to limit the present invention. The scope of the present invention shall be defined by the appended claims and shall cover legal equivalents thereof, and is not limited to the foregoing description.

What is claimed is:

1. A display device, comprising:
a light source module, having a light emitting surface;
a light adjusting module, disposed on the light emitting surface of the light source module and having a plurality of predetermined positions;
a display panel, disposed on the light adjusting module and having a display surface; and
an eye detection device, adjacent to the display surface, for detecting an eye position of a user located in front of the display surface, wherein
the light adjusting module is capable of adjusting an optical property of the plurality of predetermined positions of the light adjusting module in accordance with the eye position detected by the eye detection device and a light field of the light source module.

2. The display device according to claim 1, wherein the light adjusting module is capable of adjusting the optical property of the plurality of predetermined positions of the light adjusting module in accordance with a perpendicular distance between the eye position detected by the eye detection device and the display surface.

3. The display device according to claim 1, wherein the light adjusting module adjusts the optical property of the plurality of predetermined positions of the light adjusting module in accordance with a perpendicular distance between the eye position and a central normal line of the display surface.

4. The display device according to claim 1, wherein the light adjusting module adjusts haze or light flux of the plurality of predetermined positions of the light adjusting module in accordance with the eye position detected by the eye detection device.

5. The display device according to claim 4, wherein when the eye position detected by the eye detection device is located right in front of the display panel, the light adjusting module gradually decreases haze of the light adjusting module from a center to an outside.

6. The display device according to claim 4, wherein when the eye position detected by the eye detection device is located diagonally in front of the display panel, the light adjusting module gradually decreases haze of the light adjusting module from a first predetermined position to a second predetermined position, wherein the first predetermined position is closest to the eye position, and the second predetermined position is far away from the eye position.

7. The display device according to claim 4, wherein when the eye position detected by the eye detection device is located right in front of the display panel, the light adjusting module gradually increases light flux of the light adjusting module from a center to an outside.

8. The display device according to claim 4, wherein when the eye position detected by the eye detection device is located diagonally in front of the display panel, the light adjusting module gradually increases light flux of the light adjusting module from a first predetermined position to a second predetermined position wherein the first predetermined position is closest to the eye position, and the second predetermined position is far away from the eye position.

9. The display device according to claim 1, wherein the light adjusting module comprises:
a voltage adjusting module, comprising a plurality of first electrodes arranged along a first direction and a plurality of second electrodes arranged along a second direction different from the first direction; and
a liquid crystal layer, disposed between the first electrodes and the second electrodes, and adapted to determine a liquid crystal arrangement state in accordance with a voltage difference between a first electrode and a second electrode, so as to adjust the haze of a predetermined position of the light adjusting module at which the first electrode and the second electrode are located.

10. The display device according to claim 9, wherein the liquid crystal layer is of cholesteric liquid crystals or Polymer Dispersed Liquid Crystals (PDLCs).

11. A display device control method for controlling a display device, comprising:
(A) providing an emitted light by a light source module, so as to enable the emitted light from the light source module to transmit through a light adjusting module;
(B) detecting an eye position of a user by an eye detection device, so as to obtain an eye position signal in accordance with the eye position;
(C) receiving the emitted light from the light source module by a light adjusting module, and adjusting optical properties of a plurality of predetermined positions of the light adjusting module in accordance with the eye position signal and a light field of the light source module, so as to adjust an optical property of the emitted light transmitted through the light adjusting module; and
(D) receiving adjusted light from the light adjusting module by the display panel, and enabling the adjusted light to be transmitted through the display panel and to be emitted from the display surface.

12. The display device control method according to claim 11, wherein in step (B), a perpendicular distance between the eye position of the user and the display surface is detected by the eye detection device, and the eye position signal is obtained in accordance with the perpendicular distance.

13. The display device control method according to claim 11, wherein in step (B), a perpendicular distance between the eye position of the user and a central normal line of the display surface is detected by the eye detection device, and the eye position signal is obtained in accordance with the perpendicular distance.

14. The display device control method according to claim 11, wherein in step (C), a haze or a light flux of the plurality of predetermined positions of the light adjusting module is adjusted by the light adjusting module in accordance with the eye position signal.

15. The display device control method according to claim 14, wherein in step (C), when the eye position detected by the eye detection device is located right in front of the display panel, the haze of the light adjusting module is adjusted to be gradually decreased from a center to an outside.

16. The display device control method according to claim 14, wherein in step (C), when the eye position detected by the eye detection device is located diagonally in front of the display panel, gradually decreasing haze of the light adjusting module from a first predetermined position to a second predetermined position, the first predetermined position is closest to the eye position, and the second predetermined position is far away from the eye position.

17. The display device control method according to claim 14, wherein in step (C), when the eye position detected by the eye detection device is located right in front of the display panel, increasing light flux of the light adjusting module from a center to an outside.

18. The display device control method according to claim 14, wherein in step (C), when the eye position detected by the eye detection device is located diagonally in front of the display panel, gradually increasing light flux of the light adjusting module from a first predetermined position to a second predetermined position, the first predetermined position is closest to the eye position, and the second predetermined position is far away from the eye position.
